(19) United States
(12) Patent Application Publication
(10) Pub. No.: US 2017/0011245 A1
(43) Pub. Date: Jan. 12, 2017

(54) ARRANGEMENT FOR AND METHOD OF PROTECTING AN IMAGING LENS ASSEMBLY FROM DEGRADATION IN OPTICAL PERFORMANCE

(71) Applicant: SYMBOL TECHNOLOGIES, LLC, Lincolnshire, IL (US)

(72) Inventors: CARL D. WITTENBERG, Water Mill, NY (US); JEFFREY A. KALINOSKI, BEL AIR, MD (US)

(21) Appl. No.: 14/793,818

(22) Filed: Jul. 8, 2015

(51) Int. Cl. G06K 7/10; G02B 7/02

(52) U.S. Cl. CPC G06K 7/10831; G06K 7/10722; G02B 7/021

(57) ABSTRACT

An imaging lens assembly, especially for an imaging reader, includes a plurality of lenses mounted in a lens barrel along an optical axis. A plurality of deflectable ribs is arranged around the optical axis at one end region of the barrel. Each deflectable rib extends axially at least partly over one of the lenses. A strain relief recess is formed in the one end region of the barrel and creates a radial spacing between the deflectable ribs and the one lens. The imaging lens assembly is inserted into a passage bounded by an inner chassis wall of a chassis. The chassis wall exerts radial forces on the deflectable ribs during insertion of the imaging lens assembly to deflect the deflectable ribs relative to the barrel end region into the recess without exerting radial pressure on the one lens and degrading optical performance of the imaging lens assembly.

### BACKGROUND OF THE INVENTION

The present disclosure relates generally to an imaging lens assembly for capturing return light from a target, and, more particularly, to an imaging lens assembly operative for capturing return light from a target located over a field of view of an array of image sensors of a solid-state imager, and for projecting the captured return light onto the array during electro-optical reading of the target by image capture, and, still more particularly, to an arrangement for, and a method of, protecting such an imaging lens assembly from degradation in optical performance.

Solid-state imaging systems or imaging readers have been used, in both handheld and/or hands-free modes of operation, in many industries, such as retail, manufacturing, warehousing, distribution, postal, transportation, logistics, etc., to image various targets, such as one- and two-dimensional bar code symbols to be electro-optically decoded and read by image capture. A known imaging reader includes a solid-state imager, e.g., a one- or two-dimensional charge coupled device (CCD) or a complementary metal oxide semiconductor (CMOS) device, having a sensor array of photocells or light sensors that correspond to image elements or pixels over a field of view of the imager, and associated circuits for producing and processing electrical signals that are processed by a programmed microprocessor or controller into data indicative of the target being decoded and read. The imaging reader also includes an illuminating light assembly for illuminating the target, and an imaging lens assembly for capturing return light scattered and/or reflected from the illuminated target, and for projecting the captured return light onto the sensor array to capture an image of the illuminated target during an exposure time period.

A known imaging lens assembly comprises a plurality or group of lenses of different optical powers, such as a classical Cooke triplet, mounted along an optical axis in a cylindrical lens barrel. Sometimes, a fourth lens is added to widen the field of view. Although each lens is traditionally made of glass for improved thermal stability, at least one or more of the lenses are made of plastic due to the lighter weight and lower molded fabrication cost of plastic lenses compared with glass lenses. The lens barrel with the lenses mounted therein is inserted as a unit into a cylindrical chassis passage formed in a chassis that, in turn, is mounted in the reader. The lens barrel is press-fit in the chassis passage, typically by using crush ribs that are provided either on the outer circumferential surface of the lens barrel, or on the inner circumferential surface of the chassis passage. The crush ribs are radially compressed during insertion of the lens barrel and form an interference fit to hold the lens barrel in place within the chassis, and to fixedly position the imaging lens assembly relative to the imager so that the imaging lens assembly can accurately focus the captured return light onto the imager.

A disadvantage of this crush rib design is that the radial compression of the crush ribs also radially compresses the lens barrel, and the radial compression of the lens barrel, in turn, radially compresses one or more of the lenses therein, and especially the lens located directly radially underneath the crush ribs. When that lens is made of plastic, which is less stiff than glass, then the radial forces exerted on the plastic lens can be large enough to affect and distort its optical properties and, in turn, the imaging lens assembly may not be able to accurately focus the captured return light onto the imager. This can lead to a blurred image of the target, and an overall poor reading performance.

Accordingly, it would be desirable to provide a compact, lightweight and inexpensive, imaging lens assembly whose optical performance is not degraded upon insertion into a chassis.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of an imaging reader operative in either a handheld mode and/or a hands-free mode, for capturing return light from targets.

FIG. 2 is a schematic diagram of various components of the reader of FIG. 1.

FIG. 3 is an enlarged, perspective view of an imaging lens assembly in accordance with this disclosure for use in the reader of FIG. 1.

FIG. 4 is an enlarged, sectional view of the imaging lens assembly taken on line 4-4 of FIG. 3.

FIG. 5 is a view analogous to FIG. 4 of the imaging lens assembly mounted in a chassis for use in the reader of FIG. 1.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In accordance with one feature of this disclosure, an imaging lens assembly captures return light from a target. In a preferred embodiment, the target is a bar code symbol, and the imaging lens assembly captures return light from the symbol over a field of view of an array of image sensors of a solid-state imager, and projects the captured return light onto the array during electro-optical reading of the symbol by image capture. The imaging lens assembly includes a hollow, annular lens barrel axially extending along an optical axis between opposite barrel end regions, and a plurality of lenses mounted in the barrel and arranged along the optical axis. A plurality of deflectable ribs is circumferentially arranged around the optical axis at one of the barrel end regions. Each deflectable rib axially extends at least partly over one of the lenses. A strain relief recess is formed in the one barrel end region and creates a radial spacing between the deflectable ribs and the one lens to enable radial forces to deflect the deflectable ribs relative to the one barrel end region into the recess without exerting radial pressure on the one lens and degrading optical performance of the imaging lens assembly.

In a preferred embodiment, the deflectable ribs are equiangularly arranged around the optical axis, are axially elongated projections that extend radially outwardly of the one barrel end region, and are integral and cantilevered with the one barrel end region. The recess circumferentially extends at least partly around the optical axis and, preferably, the recess includes a pair of recess portions, each circumferentially extending at least partly around the optical axis. The one lens is advantageously constituted of a synthetic plastic material.

In accordance with another feature of this disclosure, an arrangement for protecting the imaging lens assembly from degradation in optical performance includes a chassis having an inner circumferential chassis wall bounding a hollow, annular chassis passage that axially extends along the optical axis. The above-described imaging lens assembly is inserted in the chassis passage. During and after such insertion, radial forces exerted by the chassis wall on the deflectable ribs deflect the deflectable ribs relative to the one barrel end region into the recess without exerting radial pressure on the one lens and degrading optical performance of the imaging lens assembly.

In accordance with still another feature of this disclosure, a method of protecting the imaging lens assembly from degradation in optical performance is performed by configuring the imaging lens assembly with a hollow, annular lens barrel axially extending along an optical axis between opposite barrel end regions, by mounting a plurality of lenses in the barrel and arranging the lenses along the optical axis, by circumferentially arranging a plurality of deflectable ribs around the optical axis at one of the barrel end regions, by axially extending each deflectable rib at least partly over one of the lenses, by forming a strain relief recess in the one barrel end region and creating a radial spacing between the deflectable ribs and the one lens, by axially inserting the imaging lens assembly in a hollow, annular chassis passage bounded by an inner circumferential chassis wall of a chassis, and by the chassis wall exerting radial forces on the deflectable ribs during insertion of the imaging lens assembly to deflect the deflectable ribs relative to the one barrel end region into the recess without exerting radial pressure on the one lens and degrading optical performance of the imaging lens assembly.

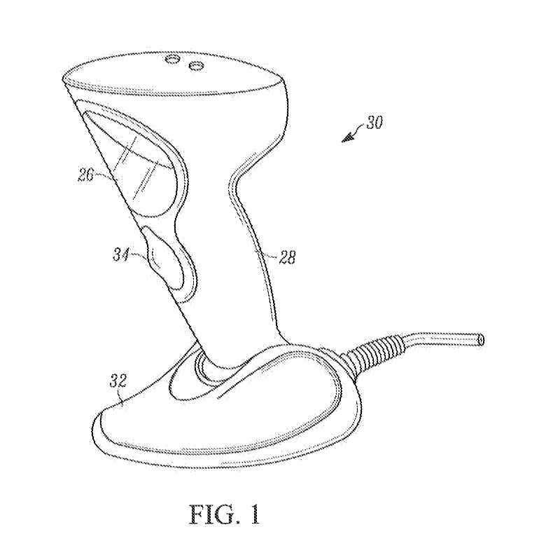

Turning now to the drawings, reference numeral 30 in FIG. 1 generally identifies an imaging reader having a light-transmissive window 26 and a gun-shaped housing 28 supported by a base 32 for supporting the imaging reader 30 on a countertop or like support surface. The imaging reader 30 can thus be used in a hands-free mode as a stationary workstation in which products bearing, or associated with, targets are slid or swiped past, or presented to, the window 26, or can be picked up off the countertop and held in an operator's hand and used in a handheld mode in which the reader is moved, and a trigger 34 is manually depressed to initiate imaging of a target, especially one- or two-dimensional symbols, to be read at a working distance from the window 26. In another variation, the base 32 can be omitted, and housings of other configurations can be employed. For example, the housing can be configured as a vertical slot scanner having a generally vertically arranged, upright window, or as a flat-bed or horizontal slot scanner having a generally horizontally arranged window, or as a bi-optical, dual window scanner having both generally horizontally and vertically arranged windows. A cable, as illustrated in FIG. 1, connected to the base 32 can also be omitted, in which case, the reader 30 communicates with a remote host by a wireless link, and the reader 30 is electrically powered by an on-board battery.

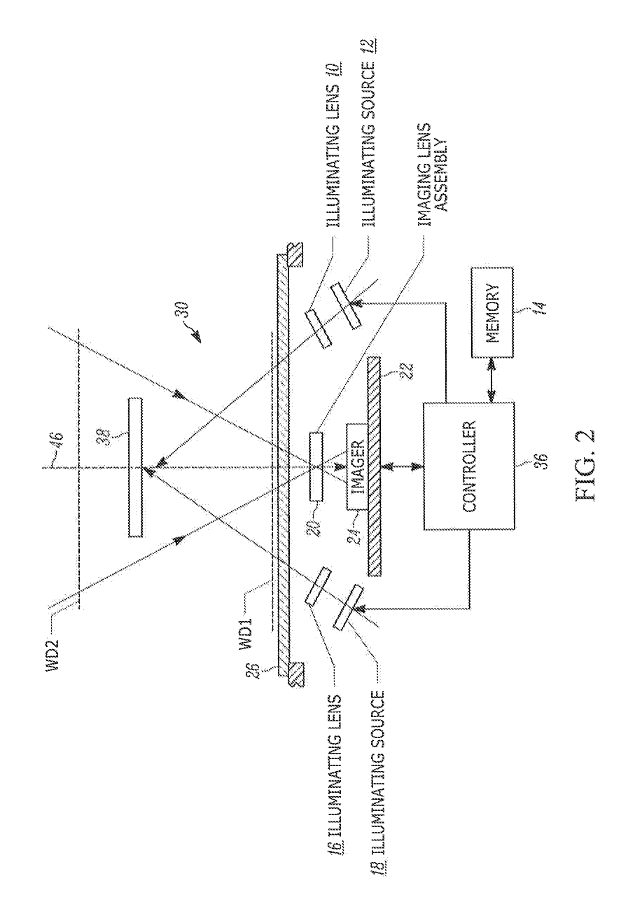

As schematically shown in FIG. 2, an imager or imaging sensor 24 is mounted on a printed circuit board 22 in the reader 30. The imaging sensor 24 is a solid-state device, for example, a CCD or a CMOS imaging sensor having a one- or two-dimensional array of addressable image sensors or pixels, arranged in a single, linear, one-dimensional row, or in a plurality of mutually orthogonal rows and columns, preferably a megapixel array, and operative for detecting return light captured by an imaging lens assembly 20 along an optical path or optical axis 46 that extends through the window 26. The return light is scattered and/or reflected from a target or symbol 38 as pixel data over a field of view. The imaging lens assembly 20 is operative for focusing and projecting the return light onto the array of image sensors to enable the target 38 to be read. The target 38 may be located anywhere in a range of working distances between a close-in working distance (WD1) and a far-out working distance (WD2). In a preferred embodiment, WD1 is about four to six inches from the imaging sensor 24, and WD2 can be many feet from the window 26, for example, around fifty or more feet away.

An illuminating light assembly is also mounted in the imaging reader 30 and preferably includes an illuminator or illuminating light sources 12, 18, e.g., light emitting diodes (LEDs), and corresponding illuminating lenses 10, 16 to uniformly illuminate the target 38 with an illuminating light having an intensity level or brightness over an illumination time period. The light sources 12, 18 are preferably pulsed.

As shown in FIG. 2, the imaging sensor 24 and the illuminating light sources 12, 18 are operatively connected to a controller or programmed microprocessor 36 operative for controlling the operation of these components. Preferably, the microprocessor 36 is operative for processing the return light from the target 38, and for decoding the captured target image when the target 38 is a symbol. A memory 14 is accessible by the controller 36 for storing and retrieving data.

In operation, the controller 36 sends a command signal to pulse the illuminating light sources 12, 18 for the illumination time period, say 500 microseconds or less, and energizes and exposes the imaging sensor 24 to collect light, e.g., illumination light and/or ambient light, from the target 38 during an exposure time period. A typical array needs about 16-33 milliseconds to acquire the entire target image and operates at a frame rate of about 30-60 frames per second.

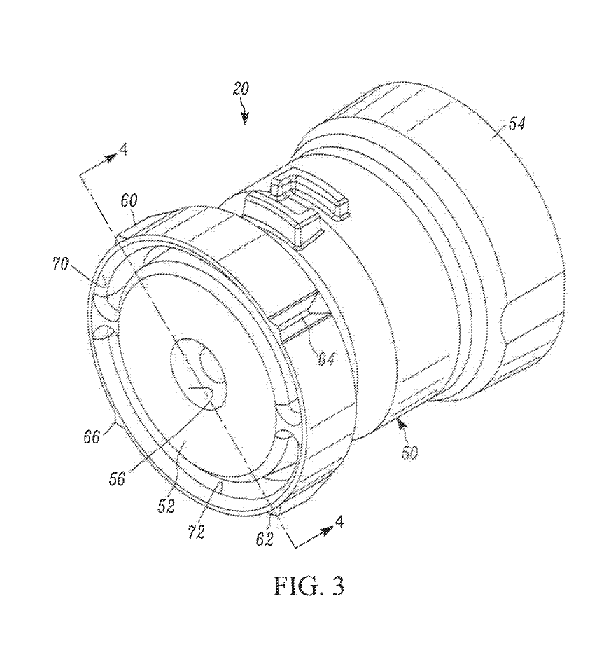

In accordance with one aspect of this disclosure, as shown in FIGS. 3-5, the imaging lens assembly 20 provided in the reader 30 includes a hollow, cylindrical lens barrel 50 axially extending along the optical axis 46 between opposite barrel end regions 52 and 54, and preferably made of a plastic material. Barrel end region 52 has an entrance opening 54 through which the return light enters the barrel 50. Barrel end region 54 has an exit opening 58 through which the return light exits the barrel 50 en route to the imager 24. A plurality or group of first, second, third, and fourth lenses L1, L2, L3 and L4 are mounted in the barrel 50 and arranged successively along the optical axis 46. The return light passes through the group of lenses along the optical axis 46. Lenses L1, L2, and L4 are each preferably made of a plastic material, and lens L3 is preferably made of glass. Lenses L1, L2, and L4 preferably each have a positive optical power, and lens L2 preferably has a negative optical power. A first baffle B1 having a central opening is sandwiched between lenses L1 and L2. A second baffle B2 having a central opening is sandwiched between lenses L2 and L3. The baffles block stray light reflections off the surfaces of the lenses inside the barrel 50.

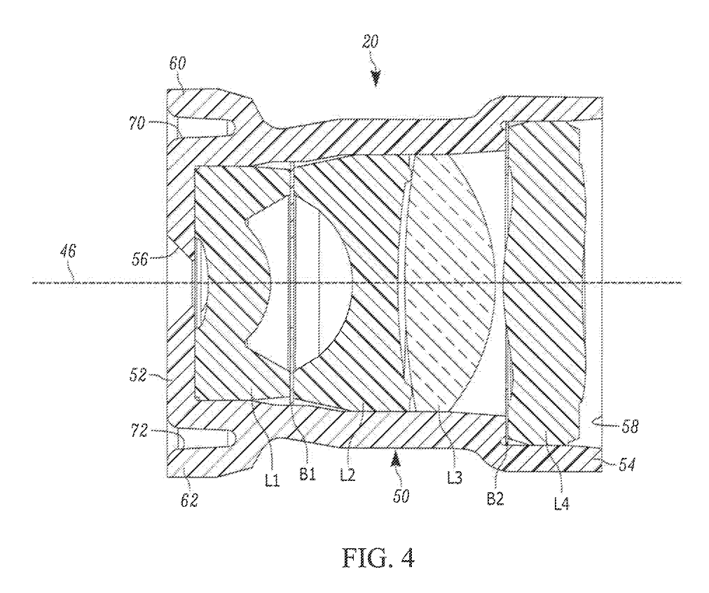

A plurality of deflectable ribs, and, as best shown in FIG. 3, preferably four deflectable ribs 60, 62, 64, and 66, are circumferentially arranged, preferably equiangularly, around the optical axis 46 at the barrel end region 52. The deflectable ribs 60, 62, 64, and 66 are axially elongated projections that extend radially outwardly of the barrel end region 52. As best shown in FIG. 4, the deflectable ribs 60, 62, 64, and 66 are integral and cantilevered with the barrel end region 52. In addition, each deflectable rib axially extends at least partly over one of the lenses, e.g., plastic first lens L1, or over a plurality of the lenses.

A strain relief recess, and, as illustrated, preferably comprised of a pair of recess portions 70 and 72, is formed in the barrel end region 52 and creates a radial spacing between the deflectable ribs and the one or more lenses to enable radial forces exerted on the deflectable ribs 60, 62, 64, and 66 to deflect the deflectable ribs relative to the barrel end region 52 into the recess portions 70 and 72 without exerting radial pressure on at least the plastic first lens L1 and degrading optical performance of the imaging lens assembly 20. The recess circumferentially extends at least partly around the optical axis 46, and each recess portion 70 and 72 circumferentially extends at least partly around the optical axis 46. Arcuate recess portion 70 is situated under the deflectable ribs 60 and 64. Arcuate recess portion 72 is situated under the deflectable ribs 62 and 66. Although two recess portions are shown, a single, circular, strain relief recess could also be employed, and more than two recess portions could also be used.

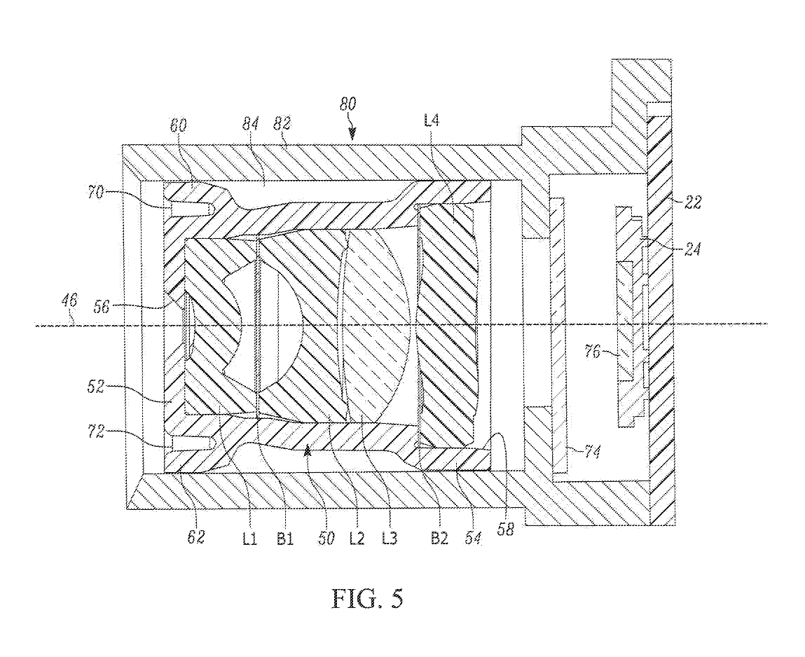

The imaging lens assembly 20 depicted in FIGS. 3-4 is inserted into a chassis 80, as best seen in FIG. 5, that is made of a cast metallic material that is more rigid than the plastic material of the barrel 50. The chassis 80 has an inner circumferential chassis wall 82 bounding a hollow, cylindrical chassis passage 84 that axially extends along the optical axis 46. Preferably, the chassis passage 84 has a draft angle that diverges toward the left in FIG. 5 to facilitate insertion of the barrel 50.

During and after such insertion, the rigid chassis wall 82 exerts radial forces on the deflectable ribs 60, 62, 64, and 66 and radially bends and deflects the deflectable ribs relative to the barrel end region 52 into the recess portions 70 and 72 without exerting radial pressure on at least the plastic first lens L1. Thus, there are greatly reduced stresses and strains on the plastic first lens L1, and its optical properties are little, or not, affected or distorted. In contrast to the compressible crush ribs of the known art, the deflectable ribs 60, 62, 64, and 66 disclosed herein are deflected radially inwardly toward the optical axis 46 with more freedom of movement.

As also shown in FIG. 5, a light-transmissive dust cover glass 74 is arranged along the optical axis 46 between the imaging lens assembly 20 and the imager 24, and is located remotely from the imager 24. The imager 24 has its own sensor cover glass 76, and the dust cover glass 70 is an extra measure of protection. The dust cover glass 74 prevents any dust generated during manufacture and insertion from falling on the sensor cover glass 76 and generating blemishes in the captured image.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or arrangement that comprises, has, includes, contains a list of elements does not include only those elements, but may include other elements not expressly listed or inherent to such process, method, article, or arrangement. An element proceeded by “comprises . . . a,” “has . . . a,” “includes . . . a,” or “contains . . . a,” does not, without more constraints, preclude the existence of additional identical elements in the process, method, article, or arrangement that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or arrangement described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An imaging lens assembly for capturing return light from a target, the imaging lens assembly comprising:
a hollow, annular lens barrel axially extending along an optical axis between opposite barrel end regions;
a plurality of lenses mounted in the barrel and arranged along the optical axis;
a plurality of deflectable ribs circumferentially arranged around the optical axis at one of the barrel end regions and extending axially at least partly over one of the lenses; and
a strain relief recess formed in the one barrel end region and creating a radial spacing between the deflectable ribs and the one lens to enable radial forces to deflect the deflectable ribs relative to the one barrel end region into the recess without exerting radial pressure on the one lens and degrading optical performance of the imaging lens assembly, and wherein the radial spacing between the deflectable ribs and the one lens prevents direct contacts between the deflectable ribs and the one lens.

2. The assembly of claim 1, wherein the deflectable ribs are equiangularly arranged around the optical axis.

3. The assembly of claim 1, wherein the deflectable ribs are axially elongated projections that extend radially outwardly of the one barrel end region.

4. The assembly of claim 1, wherein the deflectable ribs are integral and cantilevered with the one barrel end region.

5. The assembly of claim 1, wherein the recess circumferentially extends at least partly around the optical axis.

6. The assembly of claim 1, wherein the recess includes a pair of recess portions, each circumferentially extending at least partly around the optical axis.

7. The assembly of claim 1, wherein the one lens is constituted of a synthetic plastic material.

8. An arrangement for protecting an imaging lens assembly from degradation in optical performance, the arrangement comprising:
a chassis having an inner circumferential chassis wall bounding a hollow, annular chassis passage that axially extends along an optical axis, the imaging lens assembly being inserted in the chassis passage and including
a hollow, annular lens barrel axially extending along the optical axis between opposite barrel end regions;
a plurality of lenses mounted in the barrel and arranged along the optical axis;
a plurality of deflectable ribs circumferentially arranged around the optical axis at one of the barrel end regions and extending axially at least partly over one of the lenses; and
a strain relief recess formed in the one barrel end region and creating a radial spacing between the deflectable ribs and the one lens to enable radial forces exerted by the chassis wall on the deflectable ribs to deflect the deflectable ribs relative to the one barrel end region into the recess without exerting radial pressure on the one lens and degrading optical performance of the imaging lens assembly, and wherein the radial spacing between the deflectable ribs and the one lens prevents direct contacts between the deflectable ribs and the one lens.

9. The arrangement of claim 8, wherein the deflectable ribs are equiangularly arranged around the optical axis.

10. The arrangement of claim 8, wherein the deflectable ribs are axially elongated projections that extend radially outwardly of the one barrel end region.

11. The arrangement of claim 8, wherein the deflectable ribs are integral and cantilevered with the one barrel end region.

12. The arrangement of claim 8, wherein the recess circumferentially extends at least partly around the optical axis.

13. The arrangement of claim 8, wherein the recess includes a pair of recess portions, each circumferentially extending at least partly around the optical axis.

14. The arrangement of claim 8, and a solid-state imager having an array of image sensors for sensing a target to be electro-optically read, and wherein the imaging lens assembly is positioned in the chassis passage at a distance from the imager to enable the imaging lens assembly to capture return light from the target located over a field of view of the array, and to project the captured return light onto the array during electro-optical reading of the target by image capture.

15. A method of protecting an imaging lens assembly from degradation in optical performance, the method comprising:
configuring the imaging lens assembly with a hollow, annular lens barrel axially extending along an optical axis between opposite barrel end regions;
mounting a plurality of lenses in the barrel and arranging the lenses along the optical axis;
circumferentially arranging a plurality of deflectable ribs around the optical axis at one of the barrel end regions, and axially extending each deflectable rib at least partly over one of the lenses;
forming a strain relief recess in the one barrel end region and creating a radial spacing between the deflectable ribs and the one lens;
axially inserting the imaging lens assembly in a hollow, annular chassis passage bounded by an inner circumferential chassis wall of a chassis; and
the chassis wall exerting radial forces on the deflectable ribs during insertion of the imaging lens assembly to deflect the deflectable ribs relative to the one barrel end region into the recess without exerting radial pressure on the one lens and degrading optical performance of the imaging lens assembly, and wherein the radial spacing between the deflectable ribs and the one lens prevents direct contacts between the deflectable ribs and the one lens.

16. The method of claim 15, and equiangularly arranging the deflectable ribs around the optical axis.

17. The method of claim 15, and configuring the deflectable ribs as axially elongated projections that extend radially outwardly of the one barrel end region.

18. The method of claim 15, and configuring the deflectable ribs to be integral and cantilevered with the one barrel end region.

19. The method of claim 15, and circumferentially extending the recess at least partly around the optical axis.

20. The method of claim 15, wherein the inserting of the imaging lens assembly into the chassis passage is performed until the imaging lens assembly is positioned in the chassis passage at a distance from a solid-state imager having an array of image sensors for sensing a target to be electro-optically read, to enable the imaging lens assembly to capture return light from the target located over a field of view of the array, and to project the captured return light onto the array during electro-optical reading of the target by image capture.
